(19) United States
(12) Patent Application Publication
(10) Pub. No.: US 2008/0086862 A1
(43) Pub. Date: Apr. 17, 2008

(54) Repair for crankshaft ends

(75) Inventor: Orlando Da Mota Pavan, Sao Paulo (BR)

Correspondence Address: ARENT FOX LLP, 1050 CONNECTICUT AVENUE, N.W., SUITE 400, WASHINGTON, DC, 20036, US

(73) Assignee: SABO INDUSTRIA E COMERCIO LTDA

(21) Appl. No.: 11/907,041

(22) Filed: Oct. 9, 2007

(30) Foreign Application Priority Data
Oct. 11, 2006 (BR) PI 0604660-6

(51) Int. Cl. B23P 6/00

(52) U.S. Cl. 29/402.09

(57) ABSTRACT

A retainer and insert assembly used to repair a damaged end of a crankshaft. The assembly includes an insert, which is applied directly on the damaged region of the crankshaft and has a cylindrical bushing having a rubber seal layer, wherein the bushing includes a vulcanized interior surface. A retainer is disposed around the insert and which sealing contacts the bushing. A mounting and centralization device centers and mounts the insert and retainer on the crankshaft.

### BACKGROUND OF THE INVENTION

1. Field of the Invention

The present invention refers to an insert applied directly to the damaged section of a crankshaft of an internal combustion engine to repair the shaft.

2. Brief Description of Related Art

The lubrication system of conventional internal combustion engines typically use of lubricating oil. Containment of the oil inside the engine is done through a sealing system composed of several sealing devices, like retainers and others. Spaces between the engine block and the crankshaft ends are sealed with retainers having rubber and/or PTFE lips, which provide a seal directly against the surface of the shaft. With the passage of time and use of the engine, friction of the lips against the shaft forms grooves, which damage the shaft and result in the lubricating oil leaking.

In order to overcome the above described problem in the art, a known solution has been to use metallic prostheses applied on the damaged sections of the shaft. Unfortunately, this solution is rather complicated from a technical standpoint, the materials needed are rather expensive, and involves a difficult machining process. Another inconvenience of this solution is that it demands a relatively long time for it to be executed, during which the engine cannot be used.

### SUMMARY OF THE INVENTION

One aspect of the present invention is to provide a mechanism for repairing the crankshaft of the engine while overcoming the problems associated with the conventional method(s).

Another aspect of the present invention is to provide a mechanism that is easy to construct and cost effective to construct.

To achieve the above listed and other aspects, the present invention provides a kit that includes an insert and a cylindrical bushing, which are applied directly on the damaged region of the shaft. The insert includes an internal rubber layer that is able to provide an adequate seal against the shaft. A retainer is disposed around the insert and bushing sealingly secures the insert and bushing on the shaft. Moreover, an insert and retainer mounting and centralization device is used to secure the insert and retainer using the existing screws of the engine.

This way of repairing the crankshaft solves the problem verified with the usual solutions, for the fact that it is an extremely simpler assembly than the previously known solutions.

The internal rubber layer of the insert defines a mounting section and covers or otherwise protects the damaged section of the shaft while simultaneously promoting the setting and sealing of the shaft using the insert.

Moreover, because the mounting and centralization device uses the existing screws of the engine, the device also facilitates and ensures a more precise repair of the shaft while avoiding the need to use a mallet to secure the insert on the shaft as is done using the existing solutions.

Another advantage of the present invention is that the invention provides a technically simpler construction that is easy to manufacture, and which entails a reduced cost relative to the known solutions.

### BRIEF DESCRIPTION OF THE DRAWINGS

FIG. 1 is a cross-sectional view of a preferred embodiment of the present invention.

### DETAILED DESCRIPTION OF PREFERRED EMBODIMENT

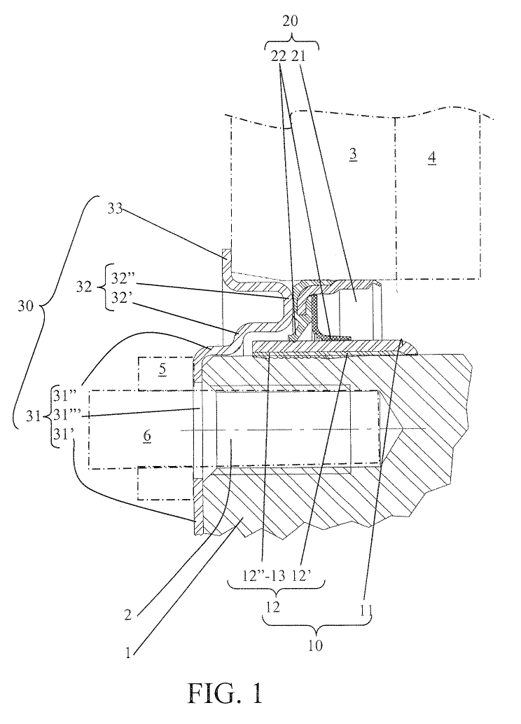

The present invention provides an integrated sealing system that is intended to be used to repair the end of a crankshaft having a wheel mounted thereon. FIG. 1 illustrates a cross-sectional view of the present invention while mounted on the damaged end of the shaft.

As the mentioned above, the present invention is intended to recover or repair crankshaft ends 1 of combustion engines that have been damaged by the retainer pressure against them. The illustrated example of the invention is used to support the following written description. The crankshaft end 1 is there area where the wheel (not shown) is mounted and includes longitudinal holes 2 that receive the setting screws of the wheel. An original seal is provided through an integrated sealing system having a flange 3 mounted, through screws, in the engine block 4 and that has mounted a sealing joint (not illustrated) between the flange and the block and a retainer that seals against the shaft end. Nevertheless, it must be further extended that the present invention can be mounted at the opposite end of the crankshaft and/or with other interstice sealing systems between the shaft and the engine block.

The present invention includes an insert 10, which is applied directly on the damaged region of the shaft. The insert 10 includes a metallic cylindrical bushing 11 and a vulcanized rubber layer 12 on the inside of the bushing, which acts to stabilize the damaged surface of the shaft while providing the seal. A retainer 20 is disposed around the insert 10 and seals against the bushing 11. A mounting device 30 of the insert 10 and retainer 20 assembly centralizes the flange 3 while using nuts 5 and the existing screws of the engine to mount the assembly on the shaft.

The rubber layer 12 of the bushing 11 is 15 mm to 30 mm in length and is formed by two sections in continuity with each other. A first conic section with lesser thickness 12′ disposed the end of the bushing 11 from which this is applied on the shaft 1, with smooth surface and intended to act as an invitation for the mounting; and a second section of greater thickness 12″ intended to be disposed on the damaged section (grooved) of the shaft 1. The second section 12″ includes a rubber layer having an average thickness of 0.7 mm and its external surface, which is in contact with the damaged surface of the shaft 1, is equipped with concentric grooves, intended to accommodate the rubber layer over the damaged surface during mounting.

The metallic bushing 11 has a length of 15 to 30 mm and thickness of 0.75 to 2.00 mm and its external surface is without errors of shape, such as scratches, cracks, creases or others, for the purpose that the retainer 20 can seal against it in an efficient way and without being damaged. The surface without errors of shape is achieved through a bushing shaping process whose parameters and procedures are determined so as to obtain the desired geometry and avoid the formation of errors of shape.

The retainer 20 is of the type formed essentially by a ring shell 21 that is set by surface interference around the shaft end to be repaired; and by sealing lips 22 of rubber and/or PTFE type material, which seal against the bushing 11. The sealing lips 22 have a radial length slightly lesser than those of the retainers that seal directly against the shaft, for the purpose of compensating the radial space occupied by the insert 10 assembly around the shaft, so that the mentioned lips are adjusted and act with efficiency in the defined space between this latter and the surface around the shaft 1.

The mounting and centralization device 30 has substantial form of a disc equipped substantially with three concentric regions: central adjustment region 31 on the shaft and of axial positioning of the insert retainer 10-20; intermediate region 32 of axial compression of the insert retainer assembly 10-20; and peripheral region 33, which also collaborates in the definition of the axial position of the insert retainer 10-20 assembly on the shaft.

The central region 31 is defined by a radial section 31′ and by an axial section 31″ peripheral to that, of adequate diameters for them to be adjusted and could slide around the shaft end; the mentioned radial section 31′, at least when the repair is intended for recovery of the shaft end of the wheel side, according to enclosed illustration, is provided with holes 31′″ in correspondence to the threaded holes of the shaft, receptors of the wheel's setting screws.

The intermediate region 32 is composed substantially by a prolonged fold of the axial section 31″, which advances axially in relation to this in the direction of the engine, equipped with adequate radial extension in order to be introduced into the defined interstice between the shaft 1 end to be repaired and a flange surface of the integrated sealing system or engine block; the mentioned fold defines, at least, first 32′ and second 32″ compression surfaces against the insert 10 and the retainer 20, respectively.

The peripheral section 22 is an extended flange of the intermediate section 32 with sufficient radial extension for contacting with region adjacent to the interstice around the shaft, in the case the flange of the integrated sealing system; the mentioned peripheral section 33 is disposed in an axial position in the mounting device 30 adequate so that when it leans on the flange of the integrated sealing system or in the engine block the insert 10 and the retainer 20 are positioned on the damaged section of the shaft 1 to be repaired.

When the repair to be done is at the shaft end of the wheel side, sealed by an integrated sealing system, according to the present example shown in the enclosed figure, the repair is used substantially in the following manner.

Once the damage of the crankshaft is detected, the wheel and the integrated sealing system assembly are dismounted. With the aid of an adequate device (not illustrated) the insert retainer assembly 10-20 is mounted inside the flange opening of the integrated sealing system 3, forming a set composed of the flange of the integrated sealing system 3, retainer 20 and insert 10. After mounting a new joint (not illustrated) on the flange 3 of the integrated sealing system this assembly (flange+retainer+insert) is mounted on the crankshaft end until the flange 3 leans on the engine block 4 and the flange is set on this with at least two opposite screws without giving the final tightening. Next, two nut 5 are applied, which also accompany the kit, in two setting screws 6 of the wheel on the shaft 1, which are presented at this instance dismounted from this latter. Then, the mounting and centralization device 30 is mounted at the shaft end 1 and against the insert retainer assembly 10-20 and the screws and nut 5-6 are applied on holes 2 disposed in opposite positions on the shaft 1. Then the nuts 5 are screwed in alternately step by step, which lean against the mounting and centralization device 30 that slides along the shaft end, the insert retainer assembly 10-20 is pushed until the central section 31 of the device 30 leans on the shaft, limiting the advance and disposing the repair on the damaged region of the shaft. The device 30 is dismounted, the flange of the integrated sealing system 3 has just been mounted on the engine block 4 and the wheel is mounted.

Within the basic construction described above, the repair, object of the present patent, can present modifications related with materials, dimensions, constructive and/or functional and/or ornamental configuration details, without deviating from the scope of the requested protection.

Within this, as it was already said, the repair can have its parts with adequate configurations for them to be used at the crankshaft end that contains the wheel or at the opposite end, these ends are sealed by an integrated sealing system or by other sealing systems.

What is claimed is:

1. An insert and retainer assembly for repairing an end of a crankshaft ends, the insert and retainer assembly comprising:
an insert applied directly on a damaged region of the crankshaft, wherein the insert comprises a cylindrical bushing having a rubber seal layer, and wherein the bushing includes a vulcanized interior surface;
a retainer disposed around the insert and which sealing contacts the bushing; and
a mounting and centralization device which centers and mounts the insert and retainer on the crankshaft.

2. The insert and retainer assembly according to claim 1, wherein the rubber seal layer of the bushing comprises:
a first conical section having a smooth outer surface; and
a second section having concentric grooves formed on an outer surface of the second section,
wherein the first conic section has a thickness that is less than a thickness of the second section, and
wherein the second section is positioned closer to a free end of the crankshaft than the first section.

3. The insert and retainer assembly according to claim 1, wherein the rubber seal layer has a length in a range of 15 mm to 30 mm.

4. The insert and retainer assembly according to claim 2, wherein the rubber seal layer has a length in a range of 15 mm to 30 mm and the thickness of the second section is approximately 0.7 mm.

5. The insert and retainer assembly according to claim 1, wherein an outer surface of the bushing is shaped to be smooth.

6. The insert and retainer assembly according to claim 1, wherein the bushing has a length in a range of 15 mm to 30 mm and a thickness in a range of 0.75 to 2.00 mm.

7. The insert and retainer assembly according to claim 1, wherein the retainer comprises:
a ring shell that is set by surface interference around the end of the crankshaft; and
at least two sealing lips disposed adjacent the ring shell and which sealing engage an outer surface of the bushing, the sealing lips having a radial length that is shorter than a length of the retainer.

8. The insert and retainer assembly according to claim 1, wherein the mounting and centralization device has a substantially disc shape and comprises:
a central adjustment region disposed on an axial end face of the end of the crankshaft;
a peripheral region; and
an intermediate region which joins the central adjustment region to the peripheral region.

9. The insert and retainer assembly according to claim 8, wherein the central adjustment region comprises an axial section that is parallel to the axial end face of the end of the crankshaft and a radial section extending from an outer perimeter of the axial section.

10. The insert and retainer assembly according to claim 9, wherein the radial section comprises a plurality of apertures defined therein and configured to receive retaining screws of a wheel to be mounted to the end of the crankshaft.

11. The insert and retainer assembly according to claim 8, wherein the intermediate region comprises a first compression surface adjacent to an outer end of the central adjustment region and a second compression surface adjacent an outer end of the first compression surface, wherein the second compression surface contacts the retainer.

12. The insert and retainer assembly according to claim 8, wherein the peripheral region extends perpendicularly relative to a longitudinal axis of the crankshaft.

13. The insert and retainer assembly according to claim 8, further comprising fastening means applied to the central adjustment region that secure the mounting and stabilization device to the axial end face of the crankshaft.
